(19) United States
(12) Patent Application Publication
(10) Pub. No.: US 2006/0244847 A1
(43) Pub. Date: Nov. 2, 2006

(54) Electronic camera device, image recording apparatus and image recording application software

(75) Inventors: Shiro Nagaoka, Ome-shi (JP); Tatsuhiko Ikehata, Ome-shi (JP); Kei Tashiro, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/411,795

(22) Filed: Apr. 27, 2006

(30) Foreign Application Priority Data
Apr. 28, 2005 (JP) 2005-132053

(51) Int. Cl. H04N 5/76

(52) U.S. Cl. 348/231.99

(57) ABSTRACT

An image file recorded on an HDD of an electronic camera device is selected by the user and a list of file names of a plurality of selected images is formed as a backup list. If the order of the file names registered in the backup list is specified, the file names are arranged in a specified order. The thus formed backup list is transmitted to an external recording equipment. A plurality of image files (image data) selected by the user are transferred to the external recording equipment according to the order described in the backup list and integrated as moving picture data.

### CROSS-REFERENCE TO RELATED APPLICATIONS

This application is based upon and claims the benefit of priority from Japanese Patent Application No. 2005-132053, filed Apr. 28, 2005, the entire contents of which are incorporated herein by reference.

### BACKGROUND

1. Field

This invention relates to an electronic camera device having a function of backing up a plurality of images shot and recorded by use of an external recording apparatus.

2. Description of the Related Art

A mobile recording medium such as a memory card formed of a semiconductor memory can be mounted on an electronic camera device such as a digital camera. Shot images can be stored in the memory card. Image data stored in the memory card is read out by the operation of the user and displayed on the liquid crystal display section mounted on the camera.

In Jpn. Pat. Appln. KOKAI Publication No. 2004-64396, a method and apparatus which read out a plurality of images shot and recorded by use of a digital camera from a memory card and form moving picture image data obtained by successively and automatically reproducing a plurality of images based on the above images are disclosed.

Recently, digital cameras on which HDDs (Hard Disk Drives) used as large-capacity recording media are mounted are developed. In the above cameras, the number of recordable still images and the recording time of moving pictures are markedly increased in comparison with the conventional digital cameras.

In a case where a plurality of picture images including still images and moving pictures are recorded in an HDD-mounting camera, the order of storage locations (addresses) of the picture images in the HDD and the order of the dates and time of the picture images shot do not always coincide with each other. That is, a plurality of picture images recorded by the HDD-mounting camera are not arranged on a time-series basis (in the order of shooting dates and time) in some cases (for example, when an old image is deleted and a new image is recorded in the thus blanked portion). In such a case, if the images are transferred from the HDD-mounting camera to an external recording equipment such as a PC (Personal Computer) and stored therein, the images are not arranged on a time-series basis. Therefore, when one moving picture data which can be used to successively and automatically reproduce a plurality of images on a time-series basis is formed based on a plurality of images recorded on the external recording equipment, the user must rearrange the plurality of images on a time-series basis.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are views showing a schematic exemplary of an electronic camera device 1 to which this invention is applied;

FIG. 2 is a block diagram showing an exemplary of the optical and electrical configurations of the electronic camera device 1;

FIG. 3 is a view showing an exemplary of a state in which a shooting menu is displayed on a liquid crystal monitor 111 by operating a menu button 117;

FIGS. 4A to 4E are views showing an exemplary of a state in which an item “album selection” is selected on the liquid crystal monitor;

FIG. 5 is a diagram showing an exemplary of a state in which a backup list according to this invention is formed;

FIG. 6 is a flowchart for illustrating an exemplary of the backup list forming operation;

FIGS. 7A and 7B are diagrams showing an exemplary of a backup list;

FIG. 8 is a view showing an exemplary of a screen used to inquire of the user about whether or not image data is integrated in album units;

FIG. 9 is a view showing an exemplary of a screen used to inquire of the user about whether or not image data is arranged on a time-series basis;

FIG. 10A is a diagram showing an exemplary of a state in which the camera 1 and an external recording equipment 200 are connected and FIG. 10B is a diagram showing an exemplary of a state in which the camera 1 and a PC are connected;

FIGS. 11A and 11B are diagrams schematically showing an image data integration process;

FIGS. 12A to 12C are diagrams showing an exemplary of a state of the integration process; and

FIG. 13 is a flowchart for illustrating an exemplary of the integration process.

### DETAILED DESCRIPTION

Various embodiments according to the invention will be described hereinafter with reference to the accompanying drawings. In general, according to one embodiment of the invention, there is provided an electronic camera device comprising a shooting section which shots optical images and selectively provides one of still images and moving pictures, a recording section which has a recording medium and records images obtained by the shooting section onto the recording medium as an image file, a display section which displays the images recorded on the recording medium, a selecting section which freely selects the images recorded on the recording medium by use of the display section, a forming section which forms a list of file names of a plurality of images selected by the selecting section as a backup list, a specifying section which specifies an order of the file names registered in the backup list, an arranging section which arranges the file names in an order specified by the specifying section in the backup list, and a transmitting section which transmits the backup list in which the file names are arranged by the arranging section to an external recording equipment which records the plurality of images.

According to the above embodiment, a plurality of images recorded in a digital camera having a large-capacity recording medium such as an HDD can be integrated in an order containing a time-series order and an order specified by the user and can be easily backed up in a mobile recording medium by use of an external recording equipment. Further, moving picture data having a story can be formed based on a plurality of images selected by the user without performing a complicated operation.

Now, one embodiment of this invention is explained with reference to the accompanying drawings.

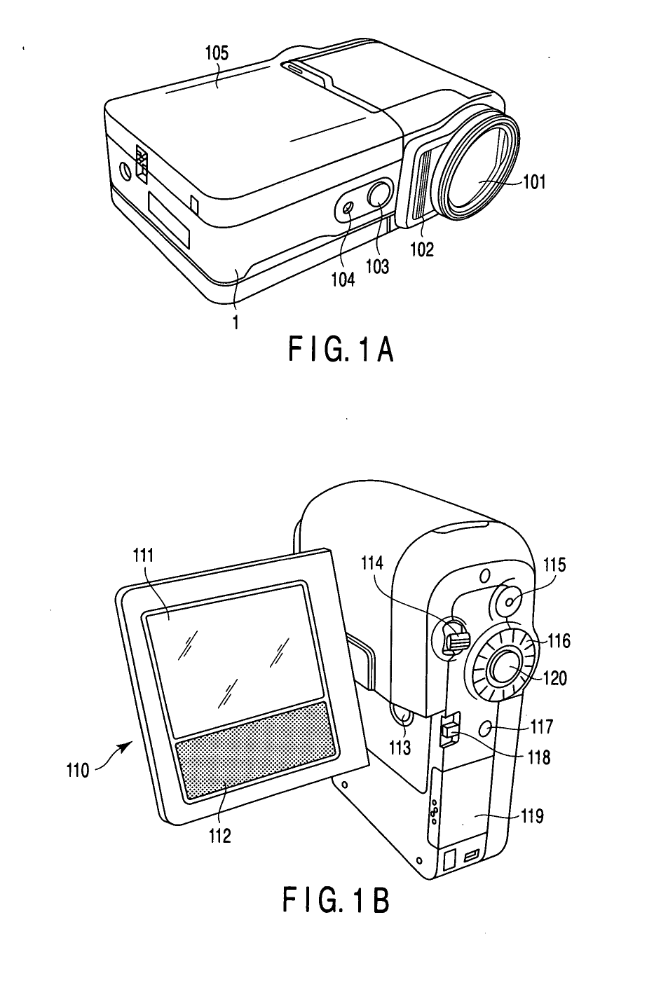

FIGS. 1A and 1B are views showing the general view of an electronic camera device 1 to which this invention is applied. FIG. 1A is a perspective view when the electronic camera device 1 is viewed from the lower front portion. A reference symbol 101 denotes a shooting lens, 102 a flash, 103 a shutter button, 104 a remote control receiving section and 105 a battery cover.

FIG. 1B is a perspective view when the electronic camera device 1 is viewed from the rear left portion. A reference symbol 111 denotes a liquid crystal monitor and 112 denotes a speaker, and they are integrally formed as a display section 110. The display section 110 is set in a concave portion of the main body of the electronic camera device 1 in the normal state and is set in an open state when it is used.

A reference symbol 115 denotes a movie recording button which is operated when the moving picture is recorded. A reference symbol 114 denotes a zoom bar which is used for zoom adjustment and 116 denotes a jog dial which is used for an operation of selecting various functions and the function selected by an OK button 120 is determined. The operation contents and state of the jog dial 116 are displayed on the liquid crystal monitor 111. A reference symbol 117 denotes a menu button which is used to provide menu display on the monitor 111 and 118 denotes a mode lever which is used to switch the shooting mode/reproduction mode. A reference symbol 119 denotes a cover for a slot in which removable semiconductor memory card is received and 113 denotes a power button for power supply turn-ON/OFF.

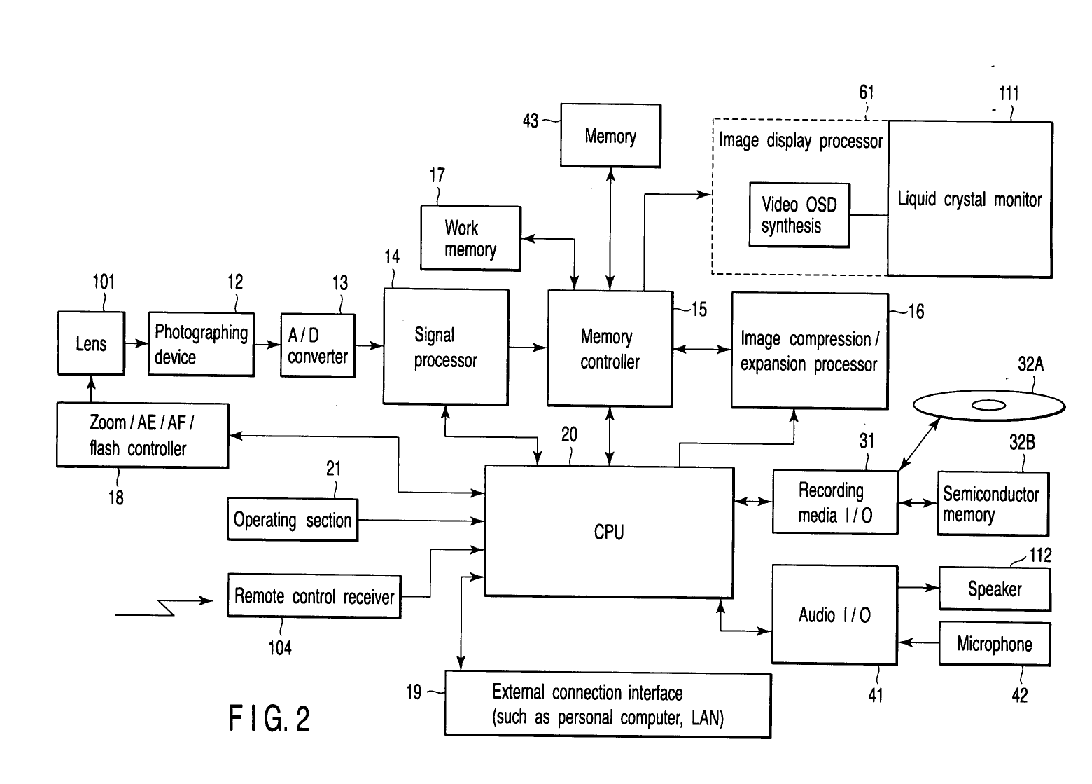

FIG. 2 is a block diagram showing an exemplary of the optical and electrical configurations of the electronic camera device 1. A subject image fetched by the lens 101 is formed on an image-forming plane of an image pickup device 12 (for example, CCD image pickup device). The subject image is converted into an electrical signal, further converted into a digital signal by an analog-digital (A/D) converter 13 and input to a signal processor 14. In the signal processor 14, gamma correction, color signal separation, white balance adjustment processes and the like are performed. The image pickup device 12, A/D converter 13, signal processor 14 and the like function as a shooting section.

When the shutter operation is not performed in the normal shooting state, video data from the signal processor 14 is input to an image display processor 61 via a memory controller 15. In the processor 61, processes such as a conversion process and menu synthesizing process to display a shot image on the liquid crystal monitor 111 are performed. Image data from the image display processor 61 is supplied to the liquid crystal monitor 111. Thus, the subject image taken by the image pickup device 12 is displayed on the liquid crystal monitor 111.

When the shutter operation is performed, shot image data is subjected to the image compression process (for example, compressed by the JPEG system) in an image compression/expansion processing section 16 and then stored in a hard disk 32A or semiconductor memory (for example, a memory which is called an SD card) 32B via a recording media I/O 31 under the control of a CPU (Central Processing Unit) 20. As the recording media, the recording media are not limited to those which are shown here and an optical disk can also be used.

When image data held in the recording medium is read out therefrom, the image data is subjected to the expansion process in the image compression/expansion processing section 16 and then input to the image display processing section 61 via the memory controller 15 under the control of the CPU 20. Thus, a reproduced image is displayed on the liquid crystal monitor 111.

A work memory 17 is used when image data is edited, a thumbnail image is formed or the order of images is rearranged, for example. Further, it is also used when various icons are edited. The work memory 17 can hold image data of one image screen or image data items of plural image screens. Since image data stored in the work memory 17 is input to the image display processing section 61 via the memory controller 15, the state of image edition can be determined by use of the liquid crystal monitor 111.

At the edition time or shooting time, audio data is fetched via a microphone 43 and audio I/O 41 under the control of the CPU 20. The audio data makes a pair together with shot image data and is recorded on the recording medium. When the recorded audio data is reproduced, it is read out together with the shot image data from the recording medium and can be output from a speaker 112 via the audio I/O 31 while the image data is being reproduced. However, in this invention, it is possible to silence the sound when the image is reproduced and determined.

An operation signal is supplied to the CPU 20 from the exterior via the operating section 21 and remote control receiver section 104. At the shooting time, the CPU 20 can perform the zoom adjustment, automatic iris adjustment (AE), automatic focus adjustment (AF) and flash control processes via the control section 18 based on the operation signal. Further, the CPU 20 is also connected to an external connection interface 19 and the camera can be connected to an external display device such as a TV receiver. In this case, the operating section 21 generally shows various operating buttons shown in FIG. 1.

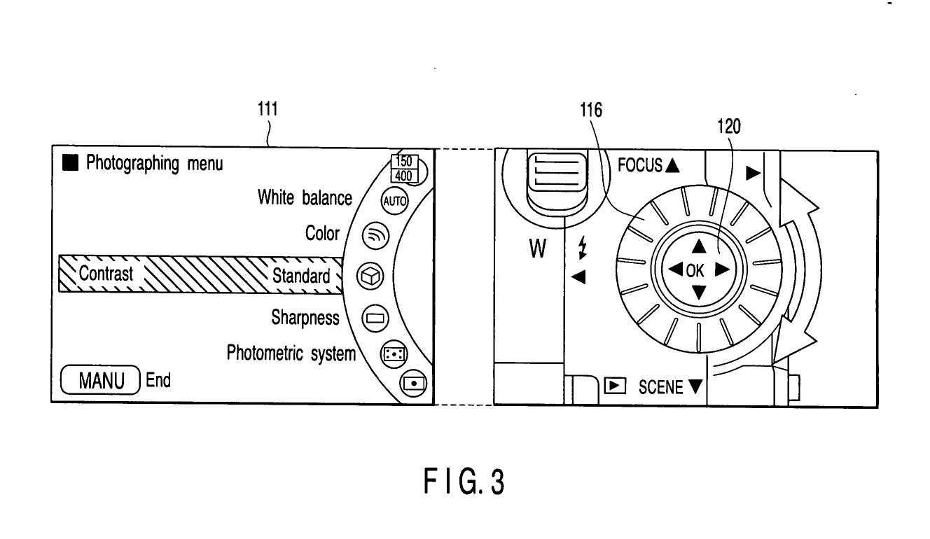

FIG. 3 shows an exemplary of a state in which a shooting menu is displayed on the liquid crystal monitor 111 by operating the menu button 117. The jog dial 116 and liquid crystal monitor 111 are arranged in adjacent positions. On the liquid crystal monitor 111, an image indicating part of an arc of the jog dial 116 is displayed. When the jog dial 116 is rotated, various items of the shooting menu are sequentially scrolled and appear on the screen and the item located at the center in the vertical direction of the screen is indicated by a cursor and selected.

If an OK button 120 is depressed when a desired item is selected, the screen is switched to a screen on which detail contents associated with the selected item are set.

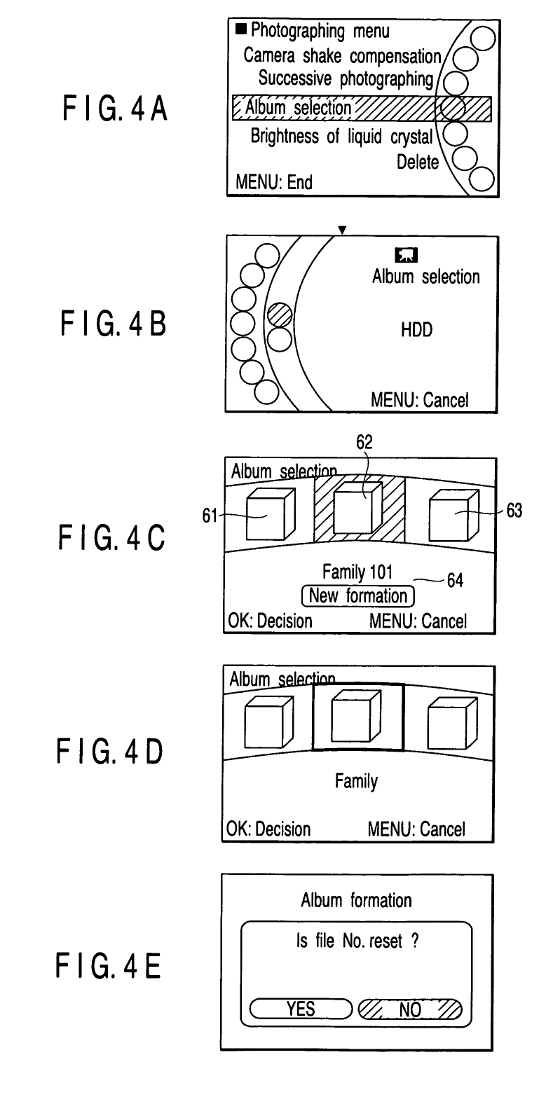

FIG. 4A is a view showing a state in which an item “album selection” is selected. If the OK button 120 is depressed in this state, an inquiry about which of the hard disk (HDD) and SD card is selected as a recording medium is made. At this time, the user can select the HDD or SD card by use of the cursor by pressing the OK button 120 in a direction of the upward triangular arrow or in a direction of the downward triangular arrow. Thus, the OK button 120 is operated like a joy stick. When the HDD is selected by use of the cursor, a display mark of “HDD” is displayed on the liquid crystal monitor 111, and when the SD card is selected, a display mark of “SD card” is displayed on the liquid crystal monitor 111. FIG. 4B shows a state in which “HDD” is selected.

In this case, if a plurality of albums already exist on the hard disk, album icons 61, 62, 63 appear according to the rotating operation of the jog dial 116. Further, in this case, it is indicated that the album of the album icon 62 located at the center can be selected. An album name 64 for the album is also displayed.

At this time, if the OK button 120 is depressed to select the album corresponding to the album icon 62, shooting data is set in correspondence to the selected album.

FIG. 4C shows a state in which an album of “family 101” is selected. However, it is sometimes desired to form a second album “family” for images shot by the son with respect to a first album “family 101” shot by the father in the family.

In such a case, the son can select an item of “new formation” by pressing the OK button 120 in a direction of the downward triangular arrow. If the OK button 120 is depressed while the “new formation” is selected, a new album is formed as shown in FIG. 4D. At this time, for example, the second album is set as “family 102”. Therefore, the first and second albums can be distinguished from each other.

Now, if the OK button 120 is further depressed, an inquiry about whether the number of the image file stored in the album is reset or not is made as shown in FIG. 4E. This is because it is preferable to set the image file numbers successive when the second album is formed to follow the first album used as the family and it is preferable to cause the respective image files to start from the initial value when the first and second albums are independently dealt with.

Also, in this case, the user can select “YES” or “NO” by pressing the OK button 120 in a direction of the upward triangular arrow or in a direction of the downward triangular arrow.

In the state of FIG. 4C, if the jog dial 116 is further rotated, the icons (61 to 63, for example) of the album are scrolled. The use can select a desired album and form a new album.

Now, a formation process of a backup list of still images and moving pictures according to this invention and an integrating process of image data items are explained.

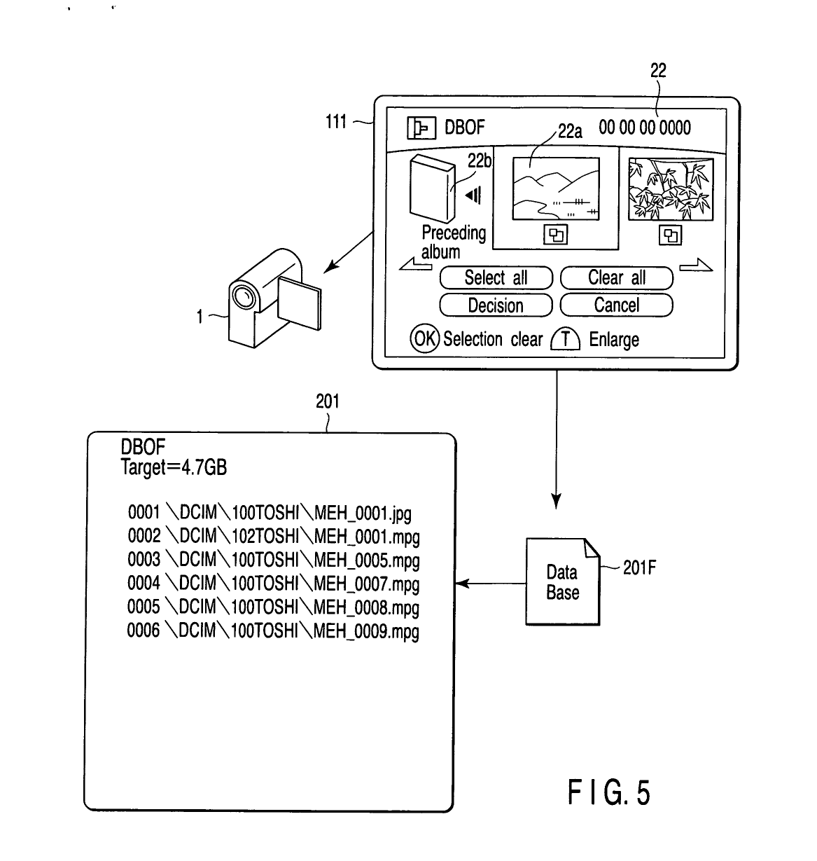

As shown in FIG. 5, the camera 1 displays a desired still image/moving picture on the screen of the liquid crystal monitor 111 by use of the display section mounted on the camera 1 and selects a desired image (still image and/or moving picture). The selected image is registered in a backup list 201 and the backup list is transmitted to an external device as a database file 201F.

The contents described in the backup list 201 are explained. “DBOF” described in an upper left portion indicates an identifier indicating that the file is a backup list, “Target=4.7 GB” indicates the capacity of a recording destination medium such as a DVD in which image data of images described in the backup list 201 is recorded. The user can freely set the capacity and register image files in the backup list 201 until the total capacity of image data recorded reaches the above capacity. The numbers “0001”, “0002”, . . . descried on the leftmost column are numbers used to determine the numbers of image files or the like and are fixed values. “DCIM” is an identifier indicating that each image file (still image file or moving picture file) is shot by the digital camera. “100TOSHI”, “101TOSHI” or the like indicates a folder name of a folder in which the image file is stored. In this specification, the folder corresponds to the album described before.

“MEH0001.jpg”, “MEH0001,mpg” or the like is a file name of each image file. In the file name, the number such as “0001” indicates a chronological order in which an image file is recorded (shot) in each folder, “jpg” indicates a still image file and “mpg” indicates a moving picture file. For example, an image file indicated by “100TOSHI/MEH0001.jpg” described in the uppermost portion indicates a still image file MEH0001.jpg which is first recorded in the folder 100TOSHI.

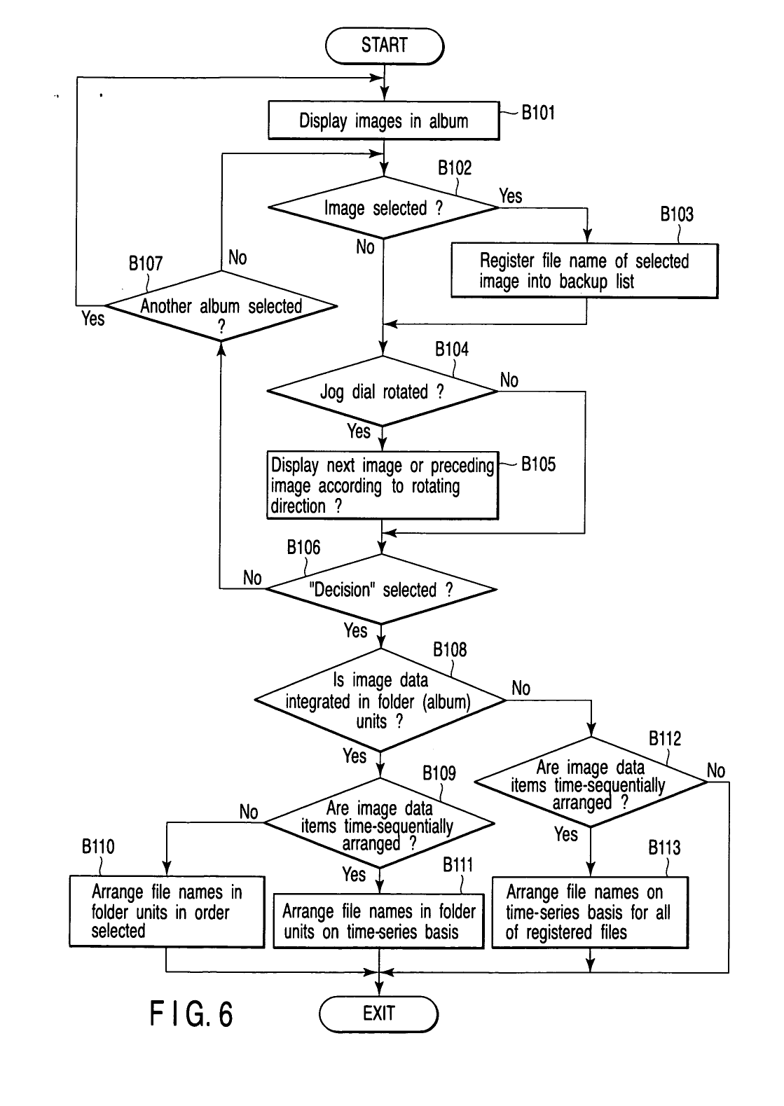

FIG. 6 is a flowchart for illustrating an exemplary of the backup list forming operation.

First, the CPU 20 displays a backup list formation screen 22 shown in FIG. 5 in response to an operation of the operating section 21 by the user (B (block) 101). A selectable image 22a is displayed in substantially the central portion of the screen 22. If the image 22a is selected by depressing the OK button 120 (“YES” in B102), the CPU 20 registers the file name of the selected image in the backup list 201 (B103).

If the jog dial 116 is rotated by the user (“YES” in B104), the CPU 20 scrolls an image displayed on the backup list formation screen 22 in a direction indicated by an arrow in the drawing according to the rotation direction of the jog dial 116 and displays the immediately preceding or succeeding image in the central portion of the screen 22 (B105). At this time, as an image next to the last image in a certain album, an icon of the next album is displayed. Further, as an image immediately preceding the first image of a certain album, an icon 22b of an immediately preceding album is displayed. The screen 22 of FIG. 5 shows this state.

If the icon 22b of the album is displayed in the central portion of the screen 22 and is selected by use of the OK button 120 (“YES” in B107), the CPU 20 displays the first image stored in the selected album in the central portion of the screen 22 (B101). Thus, the user can select images over a plurality of albums and register them in the backup list 201.

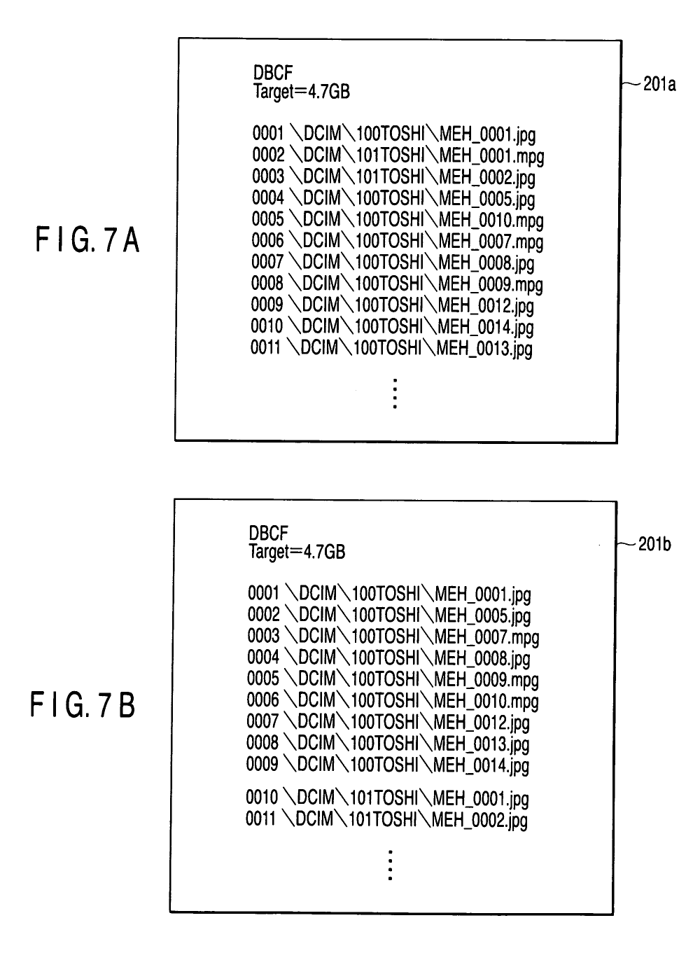

FIG. 7A shows a backup list 201a of the image files thus registered. The image files are registered in the order in which they are selected by the user. For example, first, a file MEH001.mpg first recorded in the folder 101TOSHI is registered after the file MEH001.jpg first recorded in the folder 100TOSHI is registered, and after this, a second file MEH002.jpg of the folder 101TOSHI is registered.

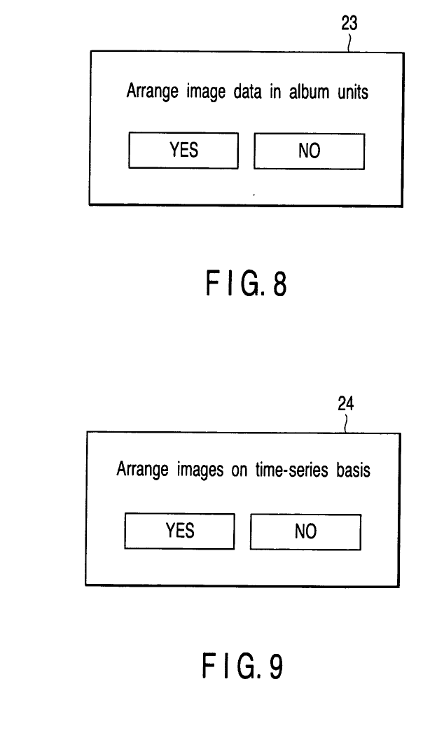

Now, the explanation is made with reference to FIG. 6 again. If “decision” in the backup list formation screen 22 is selected by the user as in B106, the CPU 20 displays a screen 23 as shown in FIG. 8 on the liquid crystal monitor 111 and inquires of the user about whether or not image data items are integrated in album (folder) units (B108). When “YES” on the screen 23 is selected (“YES” in B108), the CPU 20 displays a screen 24 as shown in FIG. 9 on the liquid crystal monitor 111 and inquires of the user about whether or not image data items are time-sequentially arranged (B109).

When “NO” on the screen 24 is selected (“NO” in B109), the CPU 20 arranges the file names of the image files in the order in which they are registered (selected) in folder units in the backup list 201. When “YES” on the screen 24 is selected (“YES” in B109), the CPU 20 arranges the file names of the image files in folder units on a time-series basis (in the chronological order in which the images are shot by the camera 1) in the backup list 201.

When “NO” on the screen 23 is selected (“NO” in B108), the CPU 20 displays the screen 24 as shown in FIG. 9 on the liquid crystal monitor 111 and inquires of the user about whether image data items are time-sequentially arranged or not (B112). When “YES” on the screen 24 is selected (“YES” in B112), the CPU 20 arranges the file names of all of the files registered in the backup list 201 on a time-series basis (B113). When “NO” on the screen 24 is selected (“NO” in B112), the CPU 20 does not rearrange the file names registered in the backup list 201.

FIG. 7B shows an exemplary of rearranging the file names in folder units on a time-series basis as in B111 as an exemplary of rearranging the file names in the backup list. For example, in the folder 100TOSHI, file names of images shot at the 1^{st}, 5^{th}, 7^{th}, 8^{th}, 9^{th}, 10^{th}, 12^{th}, 13^{th} and 14^{th} times are arranged on a time-series basis.

Now, the connection between the camera 1 according to this invention and the external recording device and personal computer application is explained.

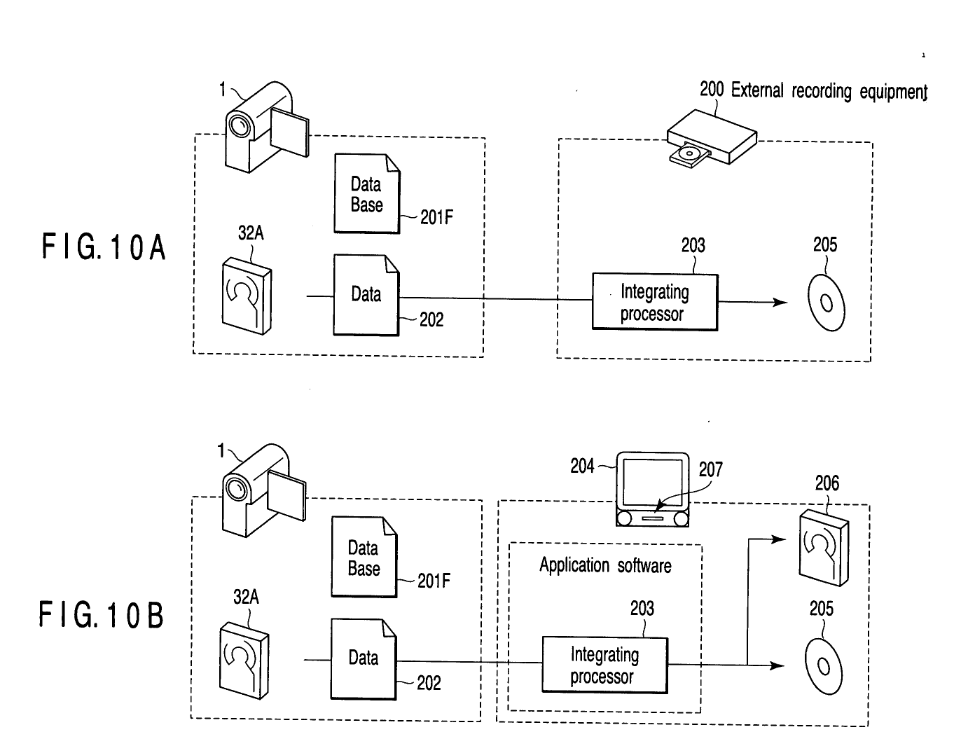

FIG. 10A shows a state in which the camera 1 and the external recording equipment 200 are connected and FIG. 10B shows a state in which the camera 1 and a PC (Personal Computer) 204 are connected. The external recording equipment 200 is an equipment which can record image data on a general-purpose mobile recording medium 205 such as a DVD. The PC 204 has a disk drive 207 which records and reproduces image data with respect to an HDD 206 and/or mobile recording medium 205. The camera 1 and the external recording equipment 200 can be connected by use of a cable such as a USB cable or by radio. Likewise, the camera 1 and the PC 204 can be connected by use of a cable such as a USB cable or by radio.

An integration processing section 203 mounted on the external recording equipment 200 or PC 204 fetches the file 201F of the backup list 201 formed as explained with reference to FIG. 5 from the camera 1 to analyze the backup list 201. Image data items are transferred from the camera 1 to the external recording equipment 200 or PC 204 according to the order of the file names described in the backup list 201 and the image data items are integrated by the integration processing section 203.

The external recording equipment 200 has the integration processing section 203 as hardware and the PC 204 has the integration processing section 203 as image recording application software. The application software can be stored in an optical disk such as a CD or HDD, loaded in a RAM (not shown) which the PC has and executed as the integration processing section 203. A data group integrated by the integration processing section 203 is recorded in the general-purpose recording medium 205 by the external recording equipment 200 or recorded in the general-purpose recording medium 205 via the HDD 206 or disk drive 207 by the PC 204.

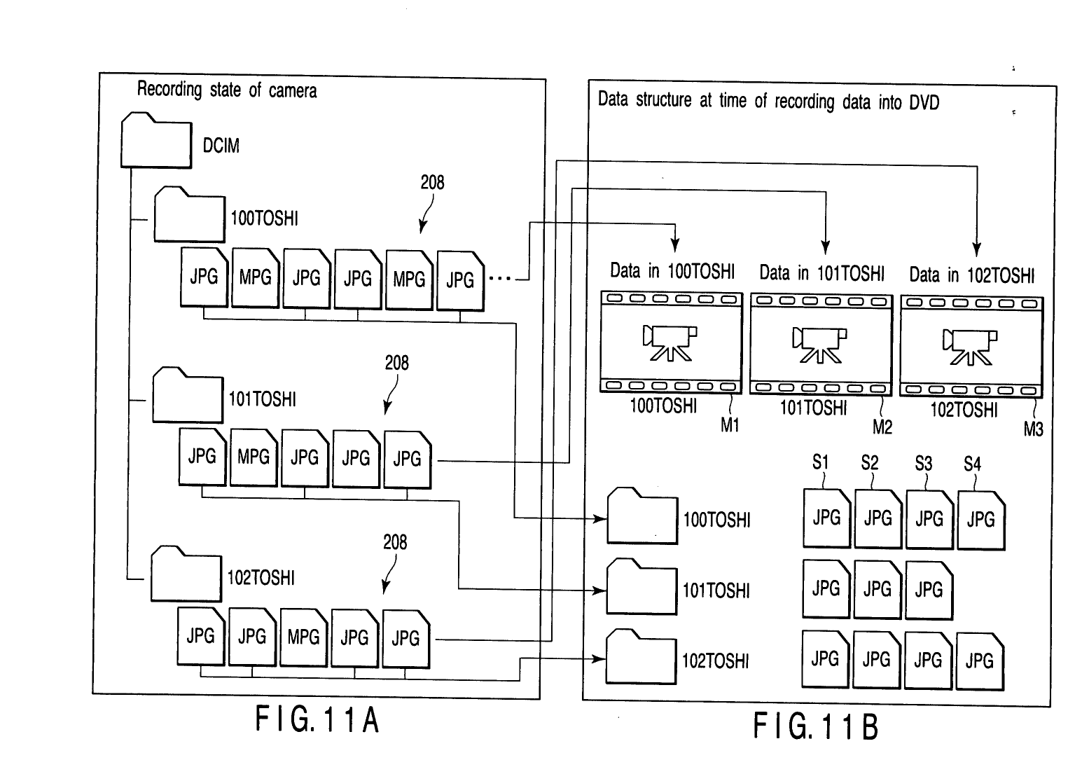

FIG. 11 is a diagram schematically showing the image data integration process.

FIGS. 11A shows image data 208 specified in the backup list 201 among the image data items recorded in the camera 1. FIG. 11B shows a state in which the image data items 208 are integrated by the integration processing section 203 mounted on the external recording equipment 200 or PC 204 and a series of moving picture data items M1, M2, M3 successively reproduced is formed and backed up in the general-purpose recording medium 205 together with still images S1, S2, . . . .

In this example, a series of moving picture data items is formed in folder units. Since three folders “100TOSHI”, “101TOSHI” and “102TOSHI” are present in FIG. 11, three picture data items M1, M2, M3 are formed. For example, the moving picture data M1 is moving picture data obtained by time-sequentially arranging still images and moving pictures in the folder “100TOSHI”, converting the still image data into a slide show movie and combining the slide show movie with the moving picture data as a series of moving pictures to be successively reproduced. The slide show movie indicates that the still images are sequentially displayed for a preset period of time as if slides of photographs are sequentially projected onto a screen.

In FIG. 11, the moving picture data items M1, M2, M3 are recorded according to the DVD-Video standard on a DVD used as a general-purpose medium and original data items of the still images are held as different files such as the still image files S1 to S4. Since the amount of one still image data is extremely larger than the amount of the moving picture data of one frame, the still image is compressed and put into moving picture data (one frame of video data based on the DVD-Video standard).

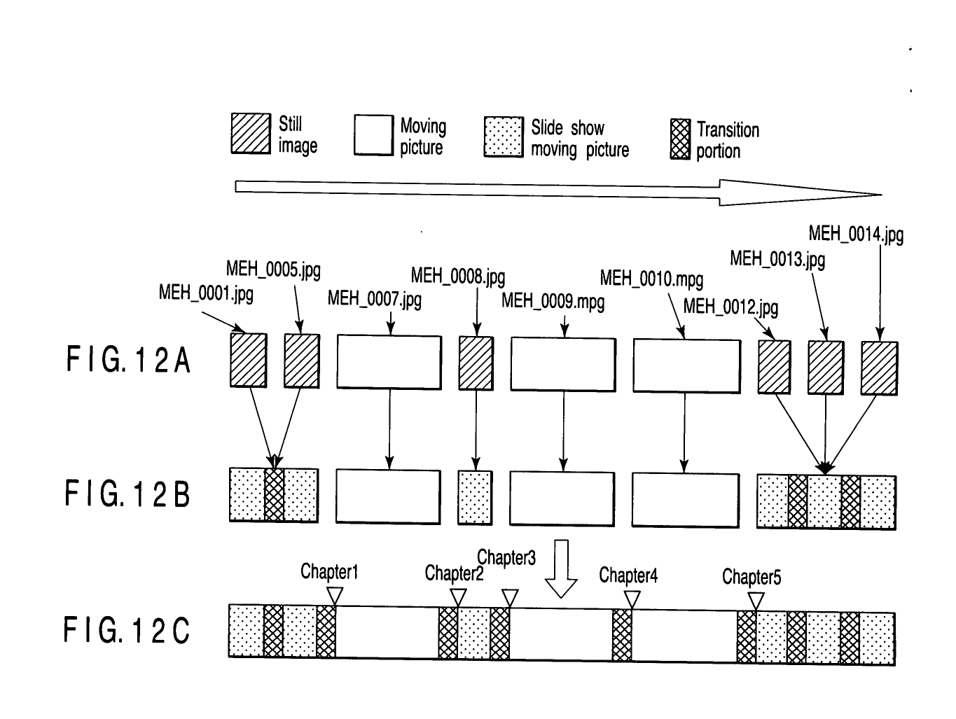

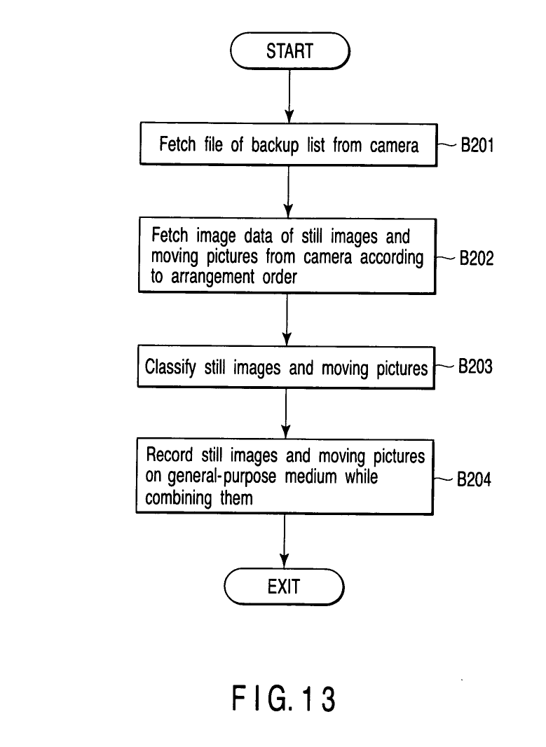

FIGS. 12A to 12C show states of the integration process and FIG. 13 is a flowchart for illustrating an exemplary of the integration process. The integration process is realized by use of the integration processing section 203 of FIG. 10.

First, the integration processing section 203 fetches the backup list 201 formed as explained with reference to FIG. 5 as a database file from the camera 1 and analyzes the same (B201). Then, the integration processing section 203 fetches image data items in the order of file names registered in the backup list 201 from the camera 1 (B202). FIG. 12 shows an example in which image data is fetched according to the backup list of FIG. 7B in which the file names are time-sequentially registered in folder units and the integration process is performed. Further, FIG. 12 shows a case wherein moving picture data associated with the folder 100TOSHI, that is, the moving picture data M1 of FIG. 11B is formed. In FIG. 12A, image data items are fetched in the order in which the shooting time is older from the left to the right. That is, MEH_{—}0001.jpg is old in time and MEH_{—}0014.jpg is new in time.

In B203, image data is classified into still image data and moving picture data as shown in FIG. 12B. In a case where a plurality of still images are arranged as shown by MEH_{—}0001.jpg and MEH_{—}0005.jpg, one slide show movie is formed by use of the plurality of still images. In a case where one still image is provided as shown by MEH_{—}0008.jpg, a slide show movie is formed by use of one still image. In the slide show movie, image frames obtained by compressing one still image are repeatedly displayed for a preset period of time for each still image.

In a case where one slide show movie is formed by use of a plurality of still images, it is possible to insert the effect (transition) into a switching portion between the still images. The transition is special effect video data which causes the vertical boundary line of a still image to move from the right to the left or causes a still image which is now displayed to be switched to a next still image as if the pages of a book is turned, for example, when a still image which is now displayed is switched to a next still image.

Thus, if all of the still images are converted into slide show movies, the slide show movies and moving picture data items are recorded onto the general-purpose medium while the data items are combined in the time-sequential order as shown in FIG. 12C (B204). In a combining portion between the slide show movie and the moving picture data, the switching effect (transition) is inserted and chapter information is automatically inserted.

In the above data flow, image data items can be combined in the time-sequential order or in the order in which the user selects the image files and one moving picture data having a story can be formed by use of still images and moving pictures which are provided together. The processes B202 to B204 are separately explained, but they can be performed as a parallel process. That is, images can be classified, integrated and recorded on a medium while the images are being fetched from the camera.

Further, the camera 1 and the external recording equipment 200 or PC are generally connected together by use of a cable such as a USB cable. When data is transferred by use of the above cable, the camera 1 functions simply as an image recording medium. That is, in the data transferring period, the camera is inhibited from performing all of the operations except the data transferring operation. Conventionally, in the recording medium of the camera, since the images are fetched into the personal computer in the order of addresses of locations in which the images are recorded, the order of transferring the images is determined based on the arrangement of the images recorded in the camera. In order to change the order of the images, it is necessary to change the arrangement of the images recorded in the camera or change the arrangement of the images on the personal computer after all of the images are transferred to the personal computer. In this invention, since the images are transferred according to the backup list and the rearrangement of the images is performed by the transferring operation, the processing efficiency is markedly enhanced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic camera device comprising:
a shooting section which shoots optical images and selectively provides one of still images and moving pictures,
a recording section which has a recording medium and records images obtained by the shooting section on the recording medium as an image file,
a display section which displays the images recorded on the recording medium,
a selecting section which selects the images recorded on the recording medium by use of the display section,
a forming section which forms a list of file names of a plurality of images selected by the selecting section as a backup list,
a specifying section which specifies an order of the file names registered in the backup list,
an arranging section which arranges the file names in an order specified by the specifying section in the backup list, and
a transmitting section which transmits the backup list in which the file names are arranged by the arranging section to an external recording equipment which records the plurality of images.

2. The electronic camera device according to claim 1, wherein the specifying section specifies one of the time-sequential order and the order in which the images are selected by the selecting section as an order of the file names.

3. The electronic camera device according to claim 2, wherein the recording section records the images in folder units, the selecting section selects the image over a plurality of folders and the specifying section specifies whether the file name is arranged in folder units.

4. An image recording apparatus connected to an electronic camera which has a recording medium, selects an image recorded on the recording medium and has a function of forming file names of the selected images in a file form as a backup list, comprising:
a reading section which reads the file of the backup list from the electronic camera device,
a fetching section which fetches images in an arrangement order of the file names registered in the backup list,
an integrating section which integrates the plurality of images fetched by the fetching section into one moving picture data which is continuously reproduced in the arrangement order of the file names, and
a recording section which records the moving picture data integrated by the integrating section on a mobile recording medium.

5. The image recording apparatus according to claim 4, wherein the electronic camera device records the images on the recording medium in folder units, the file names are registered in the backup list in the folder units, and the integrating section integrates the plurality of images in the folder units.

6. Image recording application software introduced into a personal computer connected to an electronic camera which has a recording medium, selects an image recorded on the recording medium and has a function of forming file names of the selected images in a file form as a backup list, comprising the steps of:
reading the file of the backup list from the electronic camera device,
fetching images in an arrangement order of the file names registered in the backup list,
integrating the plurality of fetched images into one moving picture data which is continuously reproduced in the arrangement order of the file names, and
recording the thus integrated moving picture data on a mobile recording medium.
